(19) United States
(12) Patent Application Publication
(10) Pub. No.: US 2012/0286223 A1
(43) Pub. Date: Nov. 15, 2012

(54) PNEUMATIC VEHICLE DOOR SPREADER

(76) Inventor: Aurelio A. Vigil, Miami, FL (US)

(21) Appl. No.: 13/103,254

(22) Filed: May 9, 2011

(51) Int. Cl. B66F 3/24

(52) U.S. Cl. 254/93 HP

(57) ABSTRACT

A pneumatic spreader for increasing the magnitude of a gap between a window or door of a motor vehicle and the vehicle body, to permit a tool to be inserted into and maneuvered through the gap. The spreader may comprise a hand operated squeeze bulb having a gas release valve and two inflatable flexible bladders inflated from the squeeze bulb through a manifolded gas supply conduit. Each bladder may be greater in length and width than in thickness, and may have an internal stiffener to facilitate initially inserting the bladder into the gap without causing the bladder to fold or roll during insertion.

### CROSS-REFERENCE TO RELATED APPLICATION

This application claims the benefit of the filing date of U.S. Design Patent Application Ser. No. 29/389,386 entitled “DUAL AIR JACK” filed Apr. 11, 2011.

### FIELD OF THE INVENTION

The present invention relates to a tool for holding a door or window of a motor vehicle spread or spaced apart from its frame, to allow for insertion of a tool through a locked door or window.

### BACKGROUND OF THE INVENTION

People frequently inadvertently lock their keys inside their motor vehicles. To avoid damaging the vehicle by breaking a window to regain entry, most people call for professional assistance in opening the vehicle. Professionals in the business of entering locked vehicles have tools which once inserted through a window engages a door lock either by the knob which typically projects upwardly at the window sill or engages the door handle. However, to be maneuvered effectively, it may become necessary to open the window or door more than just enough to pass the tool.

Holding a closed window pane or locked door in a slightly more open position may require great manual force and may occupy both hands, thereby making it impossible to wield the tool.

The prior art has a need for a practical tool which will spread or open a window pane or a door of a vehicle. Such tools exist for emergency situations, typically in which the vehicle has been involved in a collision. Such tools are designed for the emergency situation, in which opening or spreading a door is of the essence, and wherein minimizing or eliminating damage to the vehicle body is not a consideration.

A need remains for a tool which can spread or open a window pane or door in a manner not damaging either the pane or the door, or the vehicle body, for situations such as when keys are locked inside the vehicle, but there is no emergency situation.

### SUMMARY OF THE INVENTION

The present invention provides a pneumatic spreader which is adapted to apply spreading pressure at a plurality of spaced part locations. Each location, preferably two in number, is served by one expansible bladder. The two bags are manifolded from a single source of pneumatic pressure using flexible hoses which allow for versatility in positioning each bag advantageously. The source of pressure may comprise a hand squeezed bulb and a flexible supply hose, so that the source of pressure may be moved out of the way after the spreader bags are suitably inflated. A manual valve may release pneumatic pressure to remove the bags or for storage between uses.

The expansible bladders are significantly greater in length and width than in thickness, so that they may be easily inserted into gaps and may transfer pneumatic pressure over relatively great area of a window pane or door to the body of the vehicle. The expansible bladders may include stiffeners to assist in inserting each bladder into a gap, without the bladder ineffectually bending or rolling up during insertion.

It is an object of the invention to provide a pneumatic spreader which can apply spreading pressure at two spaced apart locations.

Another object of the invention is that the spreading elements be configured to readily enter gaps while still being able to transfer pressure advantageously between the spread elements of the vehicle.

A further object of the invention is that the spreading elements be able to hold their form while being inserted into gaps.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is an environmental side view of a manual pneumatic spreader according to at least one aspect of the invention.

FIG. 2 is a plan view of the manual pneumatic spreader of FIG. 1, drawn to larger scale and shown partly in cross section.

FIG. 3 is a top plan environmental detail view illustrating an important advantage of the novel manual pneumatic spreader.

FIG. 4 is a top plan environmental detail view similar to FIG. 3, but showing the consequences of providing a prior art type of spreader.

### DETAILED DESCRIPTION

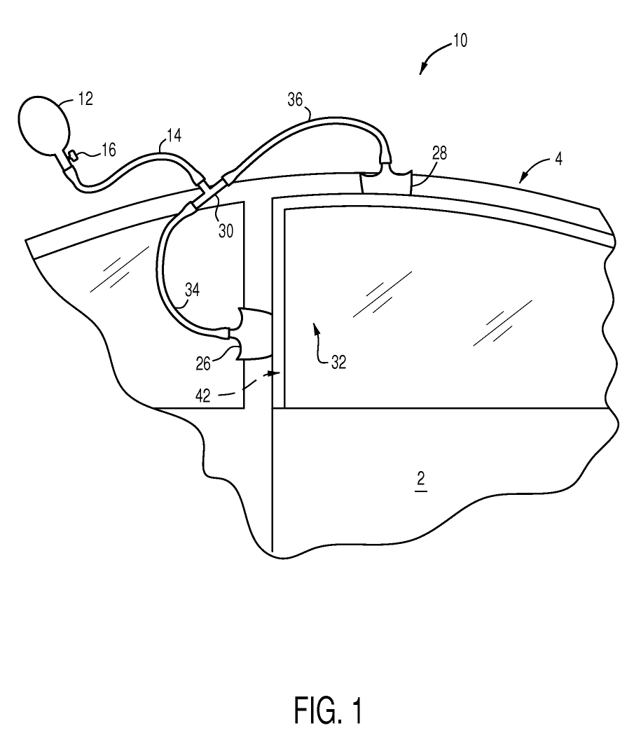

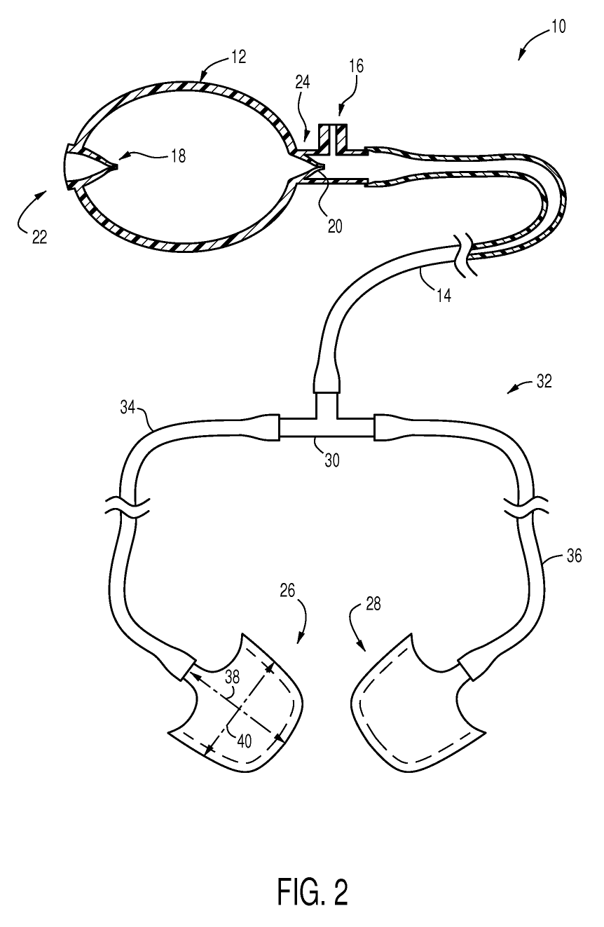

Referring first to FIGS. 1 and 2, according to at least one aspect of the invention, there is shown a manual pneumatic spreader 10 for spreading window panes and doors from vehicle bodies. In the depiction of FIG. 1, the manual pneumatic spreader 10 is shown urging the frame of a door 2 away from the body 4 of a motor vehicle (not shown in its entirety).

The manual pneumatic spreader 10 may comprise a source of pneumatic pressure, such as a squeeze bulb 12 having a flexible supply hose 14 for conducting pressurized gas such as air and a pressure release valve 16. The squeeze bulb 12 may be flexible and elastic, and dimensioned and configured to be received in and operated by one hand of a person. The person may squeeze the squeeze bulb 12 to develop pneumatic pressure. Elasticity of the squeeze bulb 12 spontaneously returns the squeeze bulb 12 to its original volume, thereby drawing in replacement air, after the person releases the squeeze bulb 12 from its compressed state. The squeeze bulb 12 may include a check valve system to enable pneumatic pressure to be developed in progressive cycles of squeezing and releasing the squeeze bulb 12. The check valve system may for example comprise an inlet flapper element 18 and an outlet flapper element 20. The inlet flapper element 18 and the outlet flapper element 20 may each be of well known type which opens under pressure of compression, but collapses to seal the internal chamber of the squeeze bulb when pressure of compression is released. By locating the inlet flapper element 18 at one opening 22 of the squeeze bulb 12 and the outlet flapper element 20 at an opposed opening 24 of the squeeze bulb 12, the check valve system is operable to eject pressurized air only to the supply hose 14 when squeezed, and to accept replacement air only through the opening 22.

The pressure release valve 16 may be formed as part of the squeeze bulb 12. The pressure release valve 16, shown only representatively rather than literally as many different known valves may be utilized, is disposed to release pneumatic pressure from all of the inflatable pressure bladders which form part of the manual pneumatic spreader 10. As depicted herein, the manual pneumatic spreader 10 comprises two pressure bladders 26, 28, although additional pressure bladders (not shown) could be provided if desired.

Of course, other sources of pneumatic pressure may be provided instead of or in addition to the squeeze bulb 12 if desired. For example, the source of pneumatic pressure may comprise a compressor, a reservoir of compressed gas, or a port which is matingly compatible with standard compressed air hoses and fittings (none of these options is shown).

The flexible supply hose 14 may be connected to a right angled tee fitting 30 which divides flow of pressurized gas to a branched distribution hose 32. The tee fitting 30 is disposed to connect each branch of the branched distribution hose 32, such as a first distribution hose section 34 and a second distribution hose section 36 to the squeeze bulb 12. As seen in the depiction of FIG. 2, each branch of the branched distribution hose 32 projects at a right angle from the flexible supply hose 14 and oppositely from the other branch of the branched distribution hose 32.

The branched distribution hose 32 is disposed to receive pressurized gas from the squeeze bulb 12 and to deliver received pressurized gas to the separate, spaced apart pressure bladders 26, 28 through the first distribution hose section 34 connected to the pressure bladder 26 and the second distribution hose section 36 connected to the pressure bladder 28. Because the branched distribution hose 32 has a conduit path common to both of the pressure bladders 26, 28 and also the squeeze bulb 12, it follows that the branched distribution hose 32 maintains equal gas pressure in each of the pressure bladders 26, 28.

The pressure bladder 26 comprises a flexible elastic bladder having substantially greater length (indicated by an arrow 38 in FIG. 2) and width (indicated by an arrow 40 in FIG. 2) than thickness. The thickness is of course the third orthogonal dimension of the pressure bladder 26, not visible in the views of FIGS. 1 and 2. The length and width of the pressure bladder 26 may be for example at least twice the magnitude as the depth thereof. These dimensional relationships assure that the pressure bladder 26 is capable of occupying a gap of limited magnitude, such as the gap 42 existing between the window pane or door 2 on one hand and the vehicle body 4 on the other hand, while still presenting a significant breadth of pressurized surface on the window pane or door 2. It may be said here that although the pressure bladders 26, 28 are shown prying the door 2 away from the body 4, in some cases (not shown), it would be possible to utilize the pressure bladders 26, 28 to pry a glass window pane away from the surrounding frame formed in the door of a vehicle.

The pressure bladder 26 may comprise a stiffener disposed to maintain a straight shape of the pressure bladder 26 along one or both of the length and the width (indicated by respective arrows 38, 40) such that the pressure bladder 26 may be inserted into a gap such as the gap 42 (see FIG. 1) without ineffectually bending or rolling even when the pressure bladder 26 is not inflated above ambient air pressure. Ordinarily, the pressure bladder 26 is inserted into such a gap prior to inflation, and is inflated only after suitably positioned within the gap. The stiffener facilitates successful insertion of the otherwise flaccid pressure bladder 26. In the depiction of FIG. 2, the stiffener is seen to comprise an elastic member 44 bent to the shape of a “U” and located internally to the pressure bladder 26, but which is biased by spring force to assume a straight configuration. The stiffener may take any of a number of forms. The stiffener could for example be provided by forming thickened areas such as ribs (not shown) in the wall of the pressure bladder 26.

The pressure bladder 28 may take all of the structural and functional features of the pressure bladder 26, and hence will not be separately described.

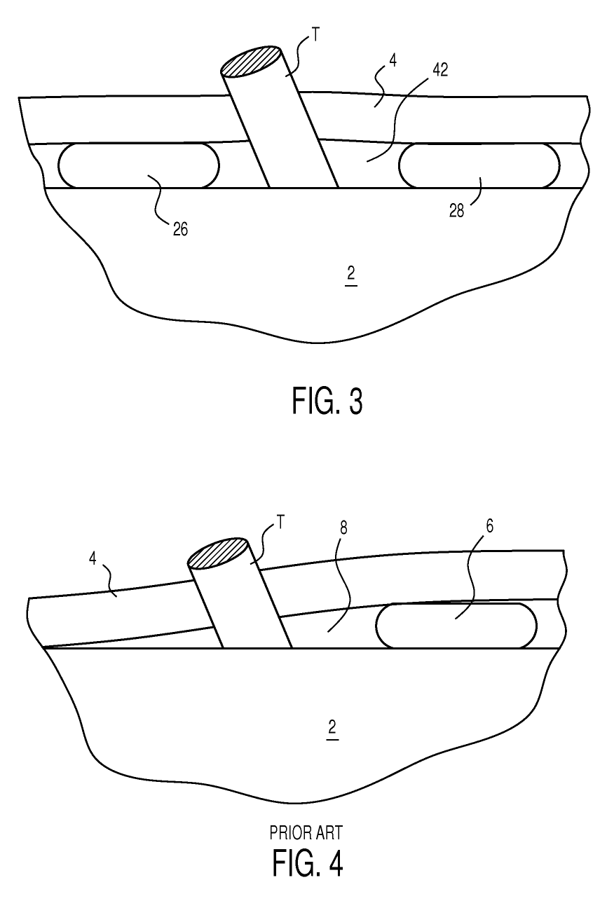

FIGS. 3 and 4 illustrate why the present invention is advantageous. FIG. 4 shows a situation which could arise should only one inflatable member such as a bladder 6 is inserted between the door 2 and body 4 of a motor vehicle. While the bladder 6 may force the door 2 away from the body 4, the resulting gap 8 may be adequately wide proximate the bladder 6, but may be too small elsewhere to permit a tool T to be maneuvered effectively into place so as to engage a door knob or door handle (neither shown) to open the door 2.

It is clearly seen in FIG. 3 that when two pressure bladders 26, 28 are provided and deployed at two spaced apart points, the resultant gap, such as the gap 42 seen in FIG. 1, may well be great enough in magnitude to permit the tool T to be effectively maneuvered into place.

Because there are two distribution hose sections 34, 36, and because both are flexible, the user of the novel manual pneumatic spreader 10 has the latitude to place the gas pressure bladders 26, 28 precisely where they will be effective.

The branched distribution hose 32 may be replaced by other arrangements. For example, each gas pressure bladder 26 or 28 may be connected directly to the source of pneumatic pressure using a dedicated hose or conduit (this option is not shown).

The elastic gas pressure bladders 26, 28 may be replaced by rigid elements, such as a pneumatically powered lever or pry device (not shown). It would also be possible to provide one gas pressure bladder such as the gas pressure bladder 26 and a pneumatically powered lever or pry device rather than two similar pneumatic expansible devices.

Spent compressed gas may be discharged by a valve located on any of the conduits or on one or all of the gas pressure bladders such as the gas pressure bladders 26, 28 if desired (this option is not shown).

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible

I claim:

1. A manual pneumatic spreader for spreading window panes and doors from vehicle bodies, comprising:
a source of pneumatic pressure comprising a flexible supply hose;
a branched distribution hose disposed to received pressurized gas from the source of pneumatic pressure and to distribute received pressurized gas to at least two separate and spaced apart pneumatically operated expansible devices while maintaining equal gas pressure in each of the pneumatically operated expansible devices, comprising at least a first distribution hose section and a second distribution hose section;
a plurality of inflatable gas pressure bladders including at least a first inflatable gas pressure bladder connected to the first distribution hose section and a second gas pressure bladder connected to the second distribution hose section; and
a pressure release valve disposed to release pneumatic pressure from all of the pneumatically operated expansible devices.

2. The manual pneumatic spreader of claim 1, wherein at least one of the pneumatically operated expensible devices comprises a flexible, elastic inflatable gas pressure bladder.

3. The pneumatic spreader of claim 2, wherein at least one of the gas pressure bladders comprises a flexible elastic bladder having substantially greater length and width than thickness, whereby the flexible elastic bladder is capable of occupying a gap of limited magnitude between the window pane or door on one hand and the vehicle body on the other hand, while still presenting a significant breadth of pressurized surface on the window pane or door.

4. The pneumatic spreader of claim 3, wherein the gas pressure bladder comprises a stiffener disposed to maintain a straight shape of the gas pressure bladder along one of the length and the width such that the gas pressure bladder may be inserted into a gap without ineffectually bending or rolling even when the gas pressure bladder is not inflated above ambient air pressure.

5. The pneumatic spreader of claim 4, wherein the stiffener is internal to the gas pressure bladder.

6. The pneumatic spreader of claim 2, wherein each one of the gas pressure bladders comprises a flexible elastic bladder having substantially greater length and width than thickness, wherein each one of the gas pressure bladders is capable of occupying a gap of limited magnitude between the window pane or door on one hand and the vehicle body on the other hand, while still presenting a significant breadth of pressurized surface on the window pane or door, the magnitude of which is at least twice the magnitude of the depth of the gas pressure bladder.

7. The pneumatic spreader of claim 6, wherein each one of the gas pressure bladders comprises a stiffener disposed to maintain a straight shape of the gas pressure bladder along one of the length and the width such that the gas pressure bladder may be inserted into a gap without ineffectually bending or rolling even when the flexible elastic bladder is not inflated above ambient air pressure.

8. The pneumatic spreader of claim 7, wherein each one of the stiffeners is internal to one of the gas pressure bladders.

9. The manual pneumatic spreader of claim 1, wherein the source of pneumatic pressure comprises a flexible squeezable bulb dimensioned and configured to be operated by one hand.

10. The manual pneumatic spreader of claim 9, wherein the pressure release valve is disposed on the flexible squeeze bulb.

11. The manual pneumatic spreader of claim 1, further comprising a right angled tee fitting disposed to connect each branch of the branched distribution hose to the supply of pressurized gas, wherein each branch of the branched distribution hose projects at a right angle from the flexible supply hose and oppositely from the other branch of the branched distribution hose.
